(19) United States
(12) Patent Application Publication
(10) Pub. No.: US 2026/0241355 A1
(43) Pub. Date: Aug. 20, 2026

(54) CALCINATION REACTOR ARRANGEMENT, CALCINATION SYSTEM AND CALCINATION METHOD

(71) Applicant: LIMEARC PROCESS AB, Njutånger (SE)

(72) Inventor: Roland LUNDKVIST, Njutånger (SE)

(21) Appl. No.: 19/161,128

(22) PCT Filed: Feb. 29, 2024
(86) PCT No.: PCT/SE2024/050191

§ 371 Date: Aug. 29, 2025

(30) Foreign Application Priority Data
Mar. 1, 2023 (SE) 2350235-4
Mar. 1, 2023 (SE) 2350236-2
Sep. 19, 2023 (SE) 2351087-8

(51) Int. Cl. B01J 6/00; B01J 8/00; B01J 8/08; B01J 8/14; C04B 2/10

(52) U.S. Cl. CPC B01J 6/004; B01J 8/001; B01J 8/005; B01J 8/087; B01J 8/14; C04B 2/10; B01J 2208/00318; B01J 2208/00398; B01J 2208/00539; B01J 2208/0084

(57) ABSTRACT

A calcination reactor arrangement includes an electrically heated primary calcination reactor chamber having an inlet for input material; and a secondary calcination reactor chamber configured to receive a flow of material from the primary calcination reactor chamber and to maintain a flow of the material through the secondary reactor chamber.

### TECHNICAL FIELD

Embodiments herein relate in general to systems, apparatuses and methods for thermal treatment of solid chemical compounds, commonly called calcination.

In particular, embodiments herein relate to systems and methods for calcination of lime mud in a lime recovery cycle for example in the cellulose industry or the cement industry.

Thus, embodiments herein relate to calcination system configurations, calcination methods and control methods for an electrically heated calcination system, particularly with an electric gas plasma generator and more particularly for calcination of lime mud.

More specifically, embodiments herein relate to reactors and reactor arrangements in plasma heated calcination systems and methods for calcination of lime mud in a lime recovery cycle, for example in the cellulose industry or the cement industry.

### BACKGROUND

In the general pursuit of adapting manufacturing and process industry to be more environmentally friendly and to decrease impact on climate change, there is a need for increasing capacity and efficiency in calcination process solutions, for example for recovery of lime in paper manufacturing, cement industry or metal industry.

In conventional industrial processes, calcination is carried out in furnaces or kilns usually heated by combustion or burning of fossil fuels or biofuels to achieve thermal decomposition of input material. This conventional kind of calcination is often environmentally unfriendly and has undesired impacts on climate change. Other drawbacks are for example that the equipment is bulky, the process time is long, the process is difficult to control, and investment costs for installation is high.

It has been proposed in patent publications WO 02/096820 and WO 02/096821 to employ calcination by means of electrically generated gas plasma in a plasma reactor. Compared to calcination with traditional furnaces or kilns, calcination in a calcination reactor heated by electrically generated gas plasma offers many advantages.

In a plasma heated calcination system, input material is exposed to heat radiation from a plasma flame incurring a temperature in parts of the calcination reactor in the range of 3000-4000 degrees Celsius. The higher temperatures that the input material, such as lime mud, is exposed to results in a faster calcination and throughput of material in the calcination process. Capacity can be increased by full scale deployment, or in existing calcination facilities by deployment, of supplementary smaller modules of electrical gas plasma calcinatory systems. Separation of carbon dioxide (CO2) can be conducted with a high degree of purity at low cost and heat can be recovered to a higher degree. Further advantages include high energy efficiency, low degree of emission, rapid process control and possibilities to make the whole lime recovery cycle more efficient.

While throughput of material and efficiency is highly increased in a plasma heated calcination system compared to a conventional furnace or kiln based calcination system, it is still desirable to increase the yield and the utilization of the generated heat.

### OBJECT

While throughput of material and efficiency is highly increased in a plasma heated calcination system compared to a conventional furnace or kiln based calcination system, it is desirable to increase still further the yield, and the utilization of the generated heat.

It is a general object of the present invention to provide improved calcination system configurations, calcination methods and control methods for electrically heated and/or plasma heated calcination.

More particular objects concern improved heat management in the calcination process as well as improved material and media flow in the calcination process.

### SUMMARY

The above indicated and other objects are achieved by embodiments of calcination systems, calcination reactor arrangements and calcination methods described herein. In embodiments, a calcination reactor is configured to convert input material, e.g. lime mud, into calcination process products comprising gas, e.g. carbon dioxide, and a solid compound, e.g. calcium oxide.

Embodiments of a calcination reactor arrangement (108,300), comprise an electrically heated primary calcination reactor chamber (222,302) having an inlet (312) for input material; a secondary calcination reactor chamber (223,306) configured to receive a flow of material from the primary calcination reactor chamber (222,302) and to maintain a flow of the material through the secondary reactor chamber (223,306).

Embodiments of a reactor arrangement (300) in a plasma heated calcination system, comprise a primary calcination reactor (302) configured to be heated by a plasma stream (308) injected into the primary calcination reactor (302), to receive input material (310) via an inlet (312), to expose the input material to heat from the plasma stream (308) in a swirling flow through the primary calcination reactor (308) and to output material that has been exposed to heat via an outlet (314) of the primary calcination reactor (302); and a secondary calcination reactor (306) configured to receive a flow of heated material from the primary calcination reactor (302) and to maintain a swirling flow of the material through the secondary reactor (306).

Further embodiments of the reactor arrangement comprise a swirl flow maintainer (304), for example in the form of a cyclone, configured to receive heated material from the primary calcination reactor (302), to reinforce and/or maintain the flow rate in a swirling flow of the received heated material, and to output material with an enhanced and/or maintained flow rate.

Embodiments of a reactor in the reactor arrangement comprises a swirl flow enhancing arrangement.

Further embodiments are disclosed in the detailed description.

### BRIEF DESCRIPTION OF DRAWINGS

Embodiments described herein will be further explained with reference to the accompanying drawings, wherein:

FIG. 1A-C show schematic overviews of calcination systems with calcination reactor arrangements in accordance with exemplifying embodiments.

FIG. 1D shows a schematic overview of an embodiment of calcination reactor and a calcination reactor arrangement.

FIGS. 2 and 2B schematically illustrate calcination systems in accordance with exemplifying embodiments.

FIG. 3 schematically illustrates an embodiment of a heat exchanger in accordance with exemplifying embodiments.

FIG. 4 schematically illustrates a calcination method in accordance with exemplifying embodiments.

FIG. 5A-E schematically illustrate exemplifying embodiments of swirl flow enhancing arrangements.

FIG. 6 schematically illustrates an embodiment of a calcination reactor comprising a first calcination chamber and a second calcination chamber in accordance with exemplifying embodiments.

### DETAILED DESCRIPTION

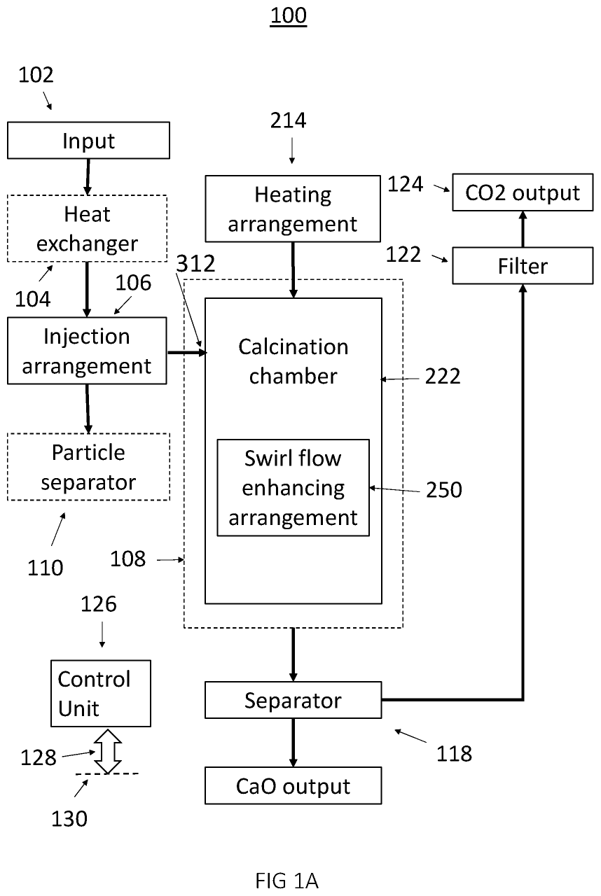

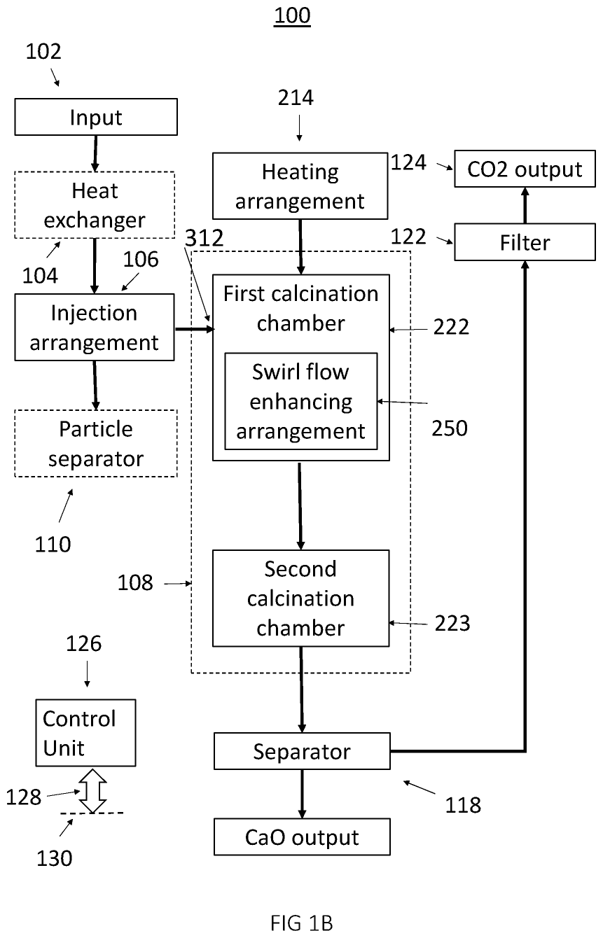

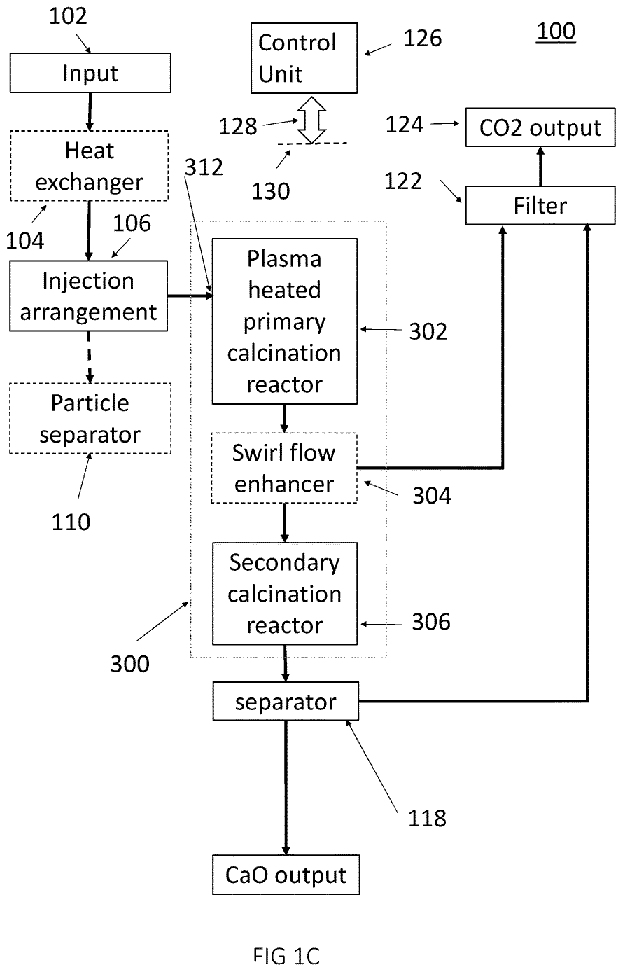

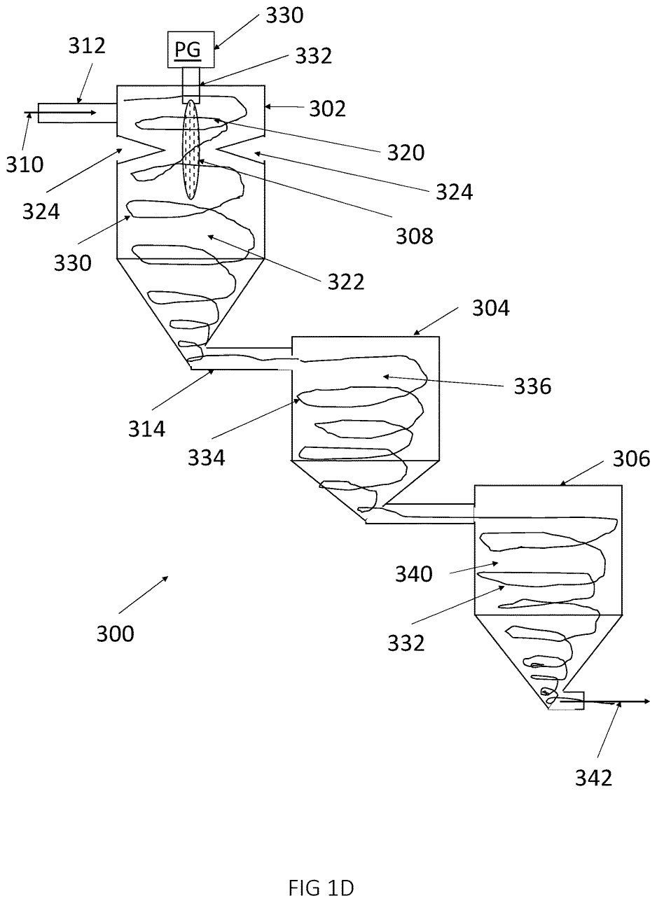

FIG. 1A-C show schematic overviews of exemplifying embodiments of a calcination system configured for carrying out embodiments of calcination methods, here exemplified by an adaptation to calcination of lime mud, for example applicable in a lime recovery cycle in the cellulose industry. However, embodiments are generally useable and/or configurable for calcination or other thermal treatment of other input materials.

In FIG. 1A-C, system components comprised or optionally comprised in embodiments are schematically shown with arrows indicating flow channels for communicating or transporting material such as solid compound and/or gas and/or heat between the components. Details drawn with intermittent lines indicate optional features in addition to the configuration of main embodiments in fully drawn lines. FIG. 1-C also serve as schematic flow charts for embodiments of calcination methods.

FIG. 1D shows a calcination reactor arrangement comprising a plasma heated calcination reactor in a configuration as a primary calcination reactor, an optional swirl maintainer and/or enhancer and a secondary calcination reactor. Material flowing in a swirling flow through the arrangement and/or its components is indicated by a schematic spiraling line.

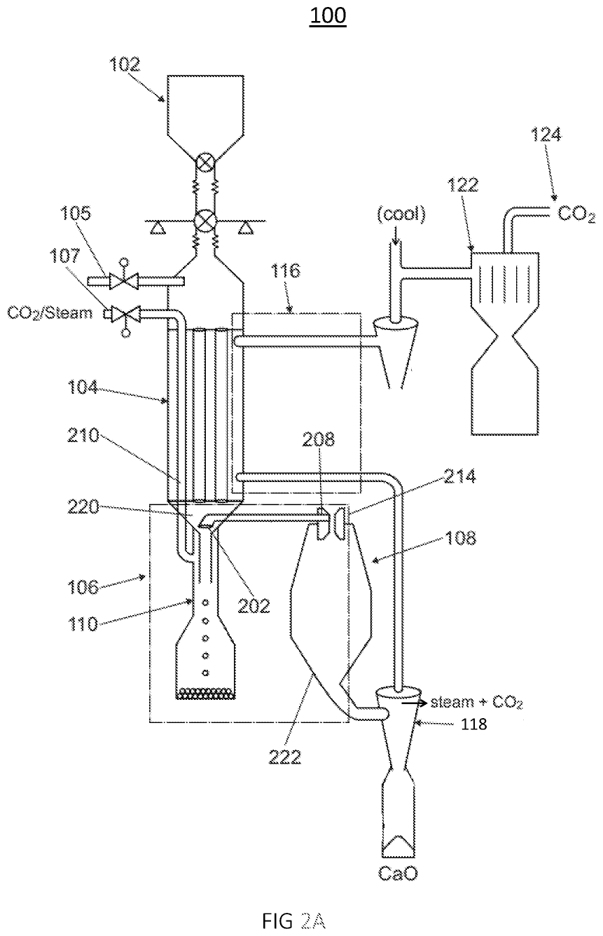

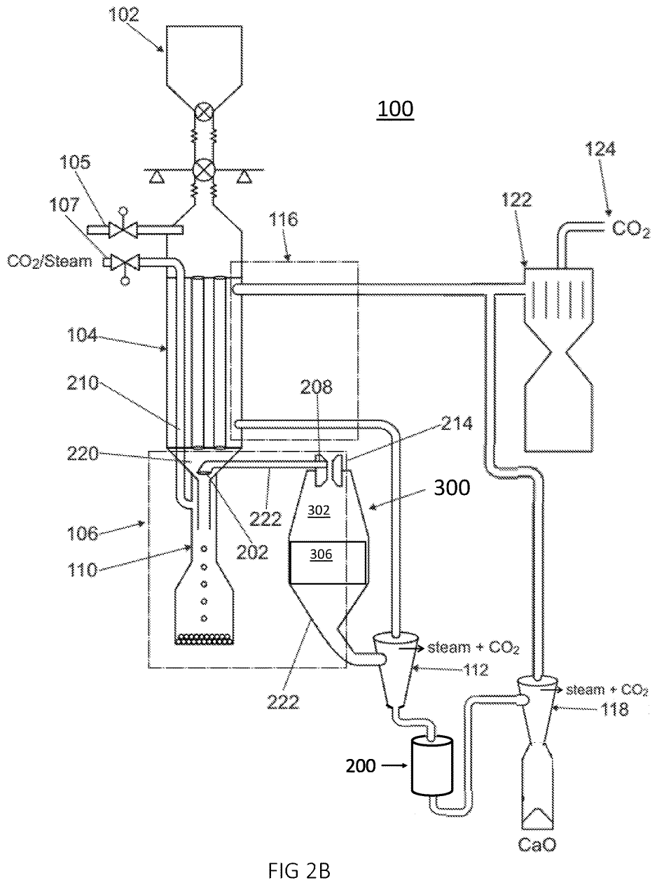

FIG. 2A-B schematically illustrate an exemplifying embodiment of a calcination system configured for carrying out embodiments of calcination methods, here exemplified by an adaptation to calcination of lime mud, for example applicable in a lime recovery cycle in the cellulose industry or cement industry.

### Calcination

Thermal treatment of a solid chemical compound is commonly called calcination. In such a process, the compound is heated to a high temperature, below the melting point of the solid chemical compound, generally under restricted supply of ambient oxygen. The general purpose may be to achieve thermal decomposition and/or to remove impurities or volatile substances.

### Calcination of Lime

Calcination of lime, in accordance with embodiments disclosed herein, is for example applicable in lime recovery cycles in process industries such as the cellulose industry, the cement industry or the metal industry. In such lime recovery cycles, lime comprising crystal forms of calcium carbonate (CaCO3) is thermally decomposed to calcium oxide (CaO), also called quick lime, and carbon dioxide (CO2). The calcination reaction is CaCO3(s)→CaO(s)+CO2(g), where (s) denotes solid compound and (g) denotes gas form compound.

For example, in the cellulose industry, lime mud is a by-product obtained in pulp mills as part of the process that turns wood into pulp for paper. In a pulp mill, wood chips are cooked with sodium hydroxide to extract the wood fiber used to make paper from the lignin that binds the wood together. During this process, sodium hydroxide is converted to sodium carbonate. Calcium oxide, also known as quick lime, is then added to convert the sodium carbonate back to sodium hydroxide, in order to use it again. In the process, calcium carbonate in the form of lime mud is obtained. Lime mud is mainly calcium carbonate mixed with water, forming a sludge. The lime mud is calcinated in order to retrieve calcium oxide in a lime recovery cycle. Before calcination, the lime mud is preferably dried to an extent suitable for handling in connection with and in the calcination process. For example, the input material such as lime or lime mud may be pulverized into a powder in connection with the drying. Similar processes as mentioned above are applicable in other industries.

Calcination of calcium carbonate begins to occur at about 900 degrees Celsius, and normally calcination takes place at temperatures in the range 900-1100 degrees Celsius, whereby calcium oxide and carbon dioxide is formed. The calcination reaction is reversible, and in order to avoid reformulation of calcium carbonate in the presence of carbon dioxide, the temperature must be maintained above the calcination temperature. However, with temperatures rising to about 1100 degrees Celsius and above, the calcium oxide sinters. In the sintering process, the calcium oxide is compacting due to the phenomenon that calcium crystals collapse and form a solid mass of material. The rate of sintering increases with higher temperatures. Furthermore, water vapor (herein also called steam) may be used as a catalyst for sintering. In the calcination process, carbon dioxide is released from the calcium carbonate, and after sintering, the calcium oxide is more stable. After such a calcination process of lime input material comprising calcium carbonates being converted into calcium oxide, also called quick lime, the quick lime is usually slaked with green liquor.

In order to make the calcination process as efficient as possible, it is desirable to use high temperatures, while avoiding sintering. When calcination of input material in the form of lime mud is carried out by means of a plasma heated reactor, there is a flow of material comprising larger and smaller particles that are exposed to high temperatures from a plasma stream. A plasma stream may also be called, for example, a plasma flame, a plasma torch or a plasma jet. The smaller particles are calcined faster than the larger particles that need a longer time of heat exposure in order to be calcined. When calcination has started, the material flow carries heat in calcined and uncalcined particles.

Aspects of the present disclosure proposes a calcination reactor arrangement, a system and a method that allows the material a longer time in calcination temperatures, by letting the input material flow through an electrically heated primary calcination reactor chamber having an inlet for input material; and a secondary calcination reactor chamber configured to receive a flow of material from the primary calcination reactor chamber and to maintain a flow of the material through the secondary reactor chamber.

Aspects of the present disclosure proposes a reactor arrangement, a system and method for more efficient calcination and utilization of heat, by letting the input material flow in a swirl through an electrically heated and/or plasma heated primary calcination reactor, and then, after an optional maintenance of the swirling flow rate, letting the calcination process continue in a secondary calcination reactor while maintaining a swirling flow of material. This allows the calcination process to continue for a longer time in order to calcine the larger particles using the heat carried by the flow of small and large particles. In embodiments, the primary calcination reactor has a primary calcination chamber and the secondary calcination reactor has a secondary calcination chamber.

The flow of material is then preferably transferred from the secondary calcination chamber to a separator where the carbon dioxide is separated from the solid compound.

Aspects of the present disclosure proposes a reactor arrangement, a system and a method for calcination that allows the material a longer time in the calcination reactor by enhancing the swirl of the material, using a swirl flow enhancing arrangement.

### Input for Material to Be Thermally Treated by Calcination

As shown in FIGS. 1A-C and 2A-B, embodiments of a calcination system 100 comprise an input 102 for material to be thermally treated, for example an input in the form of a lime mud storage container. Typically, input material such as e.g. dried lime mud is accommodated in the input 102 and may be communicated via a valve to a preheater configured to preheat the input material such as a heat exchanger, for example a media separated heat exchanger, 104, or directly to an electrically heated and/or plasma heated calcination reactor arrangement 108,300. Thus, embodiments of the calcination system comprise an input 102 for receiving input material, for example in the form of lime mud. Embodiments of a calcination method comprises receiving input material in the form of lime mud.

Embodiments for lime calcination may be configured for input material in the form of lime raw material, which herein is material comprising calcium carbonate containing minerals or substances such as limestone, lime sludge, dolomite, calcium containing sludge or the like.

### Injection Arrangement

An embodiment of the injection arrangement 106 is shown in FIG. 2A-B. The injection arrangement 106 is configured to convey and inject the input material, for example heated lime mud, into an electrically heated and/or plasma heated calcination reactor arrangement 108,300 comprising a primary calcination reactor 222,302, having a primary reactor chamber. The injection arrangement is in certain embodiments coupled to a particle separator 110. Embodiments of the calcination system 100 comprise an injection arrangement 106 configured to receive input material from the heat exchanger 104, or directly from the input 102, and to inject input material into an electrically heated and/or plasma heated calcination reactor arrangement 108,300. Embodiments of a calcination method comprises injecting input material into an electrically heated and/or plasma heated calcination reactor arrangement 108,300. It is not necessary for the system 100 to have a media separated heat exchanger 104-the input material may instead be input directly into the electrically heated and/or plasma heated calcination reactor arrangement 108,300 or via a preheater for preheating the input material.

Embodiments of the injection arrangement 106 comprises an inlet for an injection gas supply 107 configured to enable feeding of an injection gas at a controllable pressure, for example in the range of 1-5 atm (atmospheric pressure above vacuum). The purpose of the injection gas is to control the injection rate, the injection pressure, the distribution and/or the temperature of the pre-heated input material injected into the electrically heated and/or plasma heated calcination reactor arrangement 108,300. In embodiments, the inlet for injection gas supply is controllable by one or more actuators, preferably coupled to a control unit 126. In embodiments adapted to calcination of lime, the injection gas is carbon dioxide or steam. The injection gas is in embodiments recycled carbon dioxide recovered from the calcination process.

Embodiments of an injection arrangement 106 in a calcination system 100 comprises an injector inlet 202 configured to receive preheated input material, for example lime mud, from a media separated heat exchanger 104 into a fluid conductor configured for transferring the preheated input material to an injector 208; the injector 208 being configured to inject the preheated material into an electrically heated and/or plasma heated calcination reactor arrangement 108,300; and an injection gas 107 supply configured to supply gas for transfer and injection of input material into the electrically and/or plasma heated calcination reactor arrangement 108,300. In embodiments of the injection arrangement 106 the injection gas 107 is preheated in an injection gas tube 210 conducted through the media separated heat exchanger 104.

In embodiments combined with a particle separator, the injection arrangement 106 is configured such that the inlet 202 is positioned in a cavity configured to communicate preferably preheated input material, for example from the media separated heat exchanger 104, to a particle separator 110 and is configured to receive a rising flow of preheated input material in a stream of injection gas 107. The injection gas 107 is in such embodiments supplied in a flow such that smaller particles are lifted by the injection gas stream. This kind of configuration is suitable in embodiments wherein the injector 208 is configured to inject the preheated input material into a forma 214 of an electric plasma generator of a calcination reactor such as a primary calcination reactor 222,302.

In other embodiments of the injection arrangement 106, the injector 208 is configured to inject the preheated input material into a primary calcination reactor 222,302 of a calcination arrangement 108,300in an input material stream tangential in relation to a preferably rotation symmetric calcination vessel and/or in relation to a gas plasma stream generated by an electric plasma generator of the primary calcination reactor 302.

In embodiments of the injection arrangement 106 the injector inlet 202 and an outlet 218 for the injection gas supply is positioned at an outlet 220 of the media separated heat exchanger 104.

The injection arrangement described in this disclosure may be applied independently or in combination with other embodiments described herein.

### Particle Separator

The particle separator 110, also shown for example in FIG. 2A-B, is, in embodiments where it is comprised, configured to separate larger and heavier particles or lumps of preheated material, such as lime mud, from smaller and lighter particles of material. The particle separator 110 is in embodiments devised such that larger particles or lumps of material by gravity fall into a collection container and such that smaller particles (e.g. with a diameter <10 μm) are lifted by a stream of pre-heated gas and input into the injector arrangement 106.

Embodiments of the particle separator 110 are provided with a controllable supply of heated gas. In embodiments the supply of heated gas is controllable by one or more actuators, preferably coupled to control unit 126. In embodiments, the gas pressure in the particle separator 110 is controlled by controlling the driving gas supply 105 on the cold side of the media separated heat exchanger 104.

Embodiments of the calcination system 100 comprise a particle separator 110 coupled to the injection arrangement 106 and configured to separate larger lumps and smaller particles of solid compound in input material, and to convey the smaller particles in a gas flow to an injection arrangement 106 for injection into the electrically heated and/or plasma heated calcination reactor arrangement 222.

Embodiments of the calcination method comprise separating, in a particle separator 110 coupled to the injection arrangement 106, such that larger lumps and smaller particles of solid compound in input material are separated, and conveying the smaller particles in a gas flow to the injection arrangement 106 for injection into the electrically heated and/or plasma heated calcination reactor arrangement 108,300.

The particle separator may be configured or controlled such that particles of pre-heated input material with a size in the range of 1 to 1000 micrometers are input to a primary calcination reactor via the injection arrangement 106. With heated input material in powder form, the contact surface of the input material will become very large, whereby the contact time with heat in the calcination reactor can be shortened or even minimized.

The particle separator described in this disclosure may be applied independently or in combination with other embodiments described herein.

### Electrically Heated/Plasma Heated Calcination Reactor Arrangement

The electrically heated and/or plasma heated calcination reactor arrangement 108,300 is thus configured to receive a flow of pre-heated material, such as lime mud, from the injection arrangement 106 and expose the material to heat from a reactor heating arrangement 214, wherein heat is preferably generated by electricity, for example electrically generated plasma generated by an electric plasma generator. Embodiments of the calcination system comprise a primary calcination reactor 302 of a calcination reactor arrangement 108,300 being configured to convert input material received by means of the injection arrangement 106 into calcination process products comprising gas, e.g. carbon dioxide, and a solid compound, e.g. carbon dioxide. Embodiments of a calcination method comprise converting, in the electrically heated calcination reactor arrangement 108,300, input material into calcination process products comprising gas, e.g. carbon dioxide, and a solid compound, e.g. carbon dioxide.

In embodiments, the primary calcination reactor 302 of the calcination reactor arrangement 108,300 is electrically heated by an electric gas plasma generator configured to inject hot gas plasma, such as carbon dioxide plasma, into the primary calcination reactor 302, and possibly maintain production of gas plasma in the primary calcination reactor 302 from gas, such as carbon dioxide, formed in the calcination process. In embodiments applied for heat treatment of lime mud, the lime mud that is exposed to the heat of the gas plasma is converted to calcination process products in the form of calcium oxide, also called quick lime, and carbon dioxide. The primary calcination reactor 302 is further configured to exit the heat-treated material and, as normally applicable, calcination process products to a secondary calcination reactor 306.

An electric gas plasma generator, comprised in embodiments of the primary calcination reactor 302, is devised to supply energy via an electric arc formed between electrodes. Gas is ionized and an energetic gas plasma is formed. Such gas plasma normally has a temperature in the range of 3000-4000 degrees Celsius or more at the discharge of the gas plasma generator. The gas plasma generator comprises a nozzle called forma configured to inject gas plasma into the primary calcination reactor 302. Pressurized gas may be supplied to the forma to overcome a pressure drop occurring over the gas plasma generator. The pressurized gas may be used to control the temperature of the gas plasma.

Preheated input material may in the primary calcination reactor 302 be mixed with or exposed to hot gas from a reactor heating arrangement 214 in the form of a gas plasma generator. The primary calcination reactor 302 is in embodiments configured to balance the exposure of the pre-heated input material to heat at too high temperature. For example, for input material comprising lime with calcium carbonate exposure to calcination temperatures exceeding 1200 degrees Celsius may entail risk for inactivating the lime, which is also called dead burning of the lime. Configuring the calcination system such that the input material when injected into primary calcination reactor 302 is in powder form, thus having a large surface, and such that the powder formed input material is exposed to heat for a limited period of time, enables that inactivation of the input lime is avoided.

Generally, the input material is calcinated during fragments of seconds to a few seconds. Calcination is preferably carried out at atmospheric pressure, or at a small over-pressure or under-pressure.

The calcination reactor in embodiments presented herein is preferably a cyclone reactor. In a cyclone calcination reactor, particles of input material whirl in a space where calcination takes place when the material is heated. In a cyclone reactor, a whirling or rotating flow takes place in a chamber that typically has a substantially rotationally symmetric, cylindrical or conical shape. Material comprising solid particles, as well as gas, flows in a whirling or helical pattern in a space in the chamber. Normally, material is input at an upper part of the chamber, flows through the chamber and is output at a lower part of the chamber.

In embodiments, the primary calcination reactor 302 may be electrically heated using resistive technology, microwave or radio wave technology, or other electrically driven heating.

The calcination reactor arrangement and calcination reactor described in this disclosure may be applied independently or in combination with other embodiments described herein.

### Reactor Heating Arrangement

In embodiments, the calcination reactor in the calcination reactor arrangement 108,300 is heated by a reactor heating arrangement 214,330 in the form of an electric gas plasma generator configured to inject hot gas plasma, such as carbon dioxide plasma, into the calcination reactor, and possibly to maintain production of gas plasma in the calcination reactor from gas, e.g. carbon dioxide, formed in the calcination process. In embodiments applied for heat treatment of lime mud, the lime mud that is exposed to the heat of the gas plasma is converted to calcination process products in the form of gas, e.g. carbon dioxide and solid compound, e.g. calcium oxide.

A reactor heating arrangement 214,330 in the form of an electric gas plasma generator, comprised in embodiments of the calcination reactor arrangement 108,300, is devised to supply energy via an electric arc formed between electrodes. Gas is ionized and an energetic gas plasma is formed. Such gas plasma normally has a temperature in the range of 3000-4000 degrees Celsius or more at the discharge of the gas plasma generator. In a plasma heated calcination system, input material is therefore exposed to heat radiation from a plasma flame incurring a temperature in parts of the calcination reactor in the range of 3000-4000 degrees Celsius. The higher temperatures that the input material, such as lime mud, is exposed to, the faster the calcination and throughput of material in the calcination process. The gas plasma generator may comprise a nozzle called forma or tuyer, configured to inject gas plasma into a reactor chamber the calcination reactor arrangement 108,300. The forma may be cooled. Pressurized gas may be supplied to the forma to overcome a pressure drop occurring over the gas plasma generator. The pressurized gas may be used to control the temperature of the gas plasma.

In other embodiments, the calcination reactor arrangement 108,300 may be heated using electric heating such as resistive technology, microwave or radio wave technology, or any other form of heating.

The reactor heating arrangement described in this disclosure may be applied independently or in combination with other embodiments described herein.

### Swirl Flow Enhancing Arrangement

An embodiment of a calcination reactor 108 in a reactor arrangement is schematically illustrated in FIG. 2A. Input material is injected into the calcination reactor 108 through the injection arrangement 106, preferably at an angle in relation to the outer wall of the calcination reactor 108 that is selected to create a swirling flow of input material in the calcination reactor 108. The calcination reactor 108 is preferably heated by a reactor heating arrangement 214, e.g. in the form of an electric gas plasma generator that injects at least one plasma stream 230 (also called plasma jet or plasma flame) in such a way that the input material is exposed to the heat from the at least one plasma stream 230.

As schematically illustrated in FIGS. 1A-D, the calcination reactor 108 may comprise a swirl flow enhancing arrangement 250,304,324. The swirl flow enhancing arrangement 250,304,324 comprises one or more features that enhance the swirl flow in the calcination reactor 108.

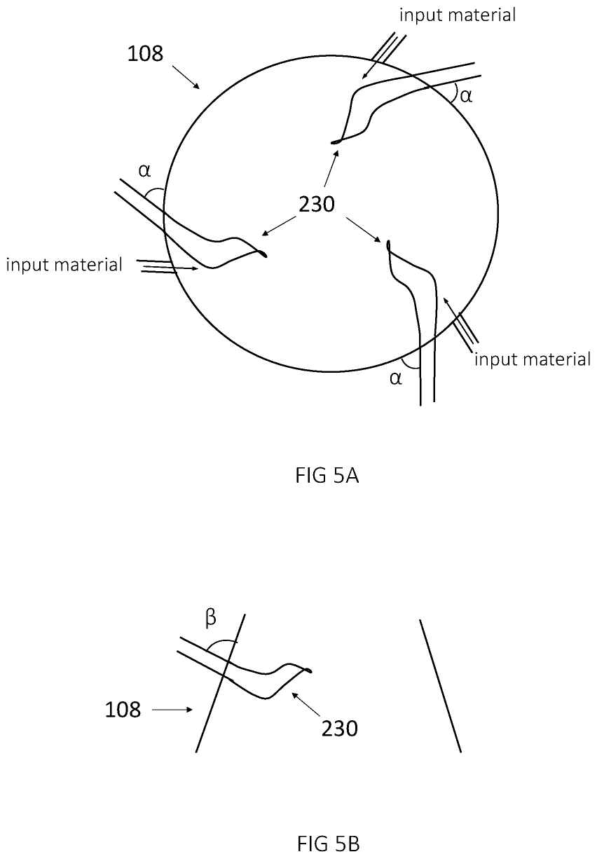

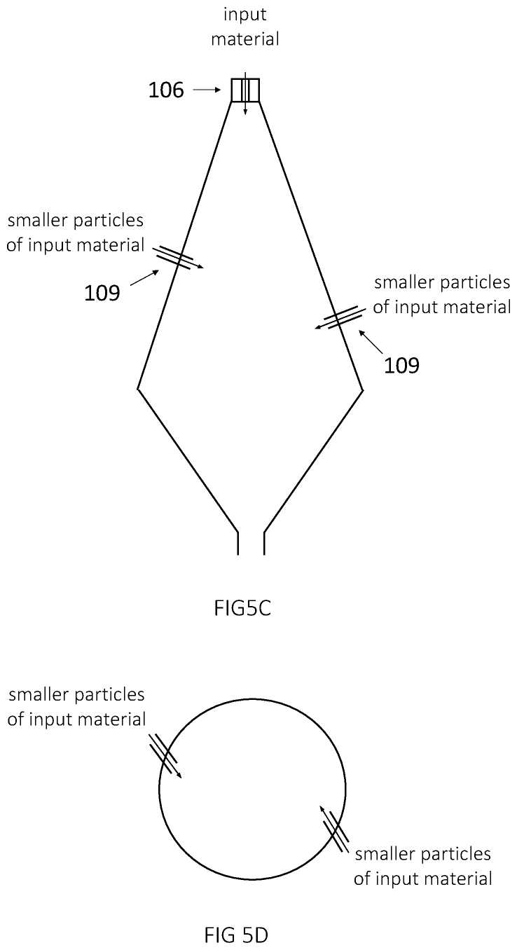

In embodiments, the swirl flow enhancing arrangement 250 comprises one or more injectors for the at least one plasma stream 230, that ensure that the at least one plasma stream 230,308 is injected into the calcination reactor 108 at an angle in relation to the outer wall of the calcination reactor 108, thereby enhancing the swirling flow of the input material. In embodiments, a plurality of plasma streams 230 are injected into the calcination reactor 108 at a horizontal angle a and a vertical angle $ in relation to the outer wall of the calcination reactor 108. This requires the calcination reactor 108 to be large enough for the plasma streams 230 not to cut through the walls of the calcination reactor 108 (however, a large calcination reactor 108 may be more cost efficient than a number of smaller calcination reactors 108, especially since the heat losses will be lower). FIG. 5A schematically illustrates a top view of an embodiment of a calcination reactor 108 comprising three plasma streams 230 injected at a horizontal angle a in relation to the outer wall of the calcination reactor 108 which is preferably smaller than 90 degrees, and FIG. 5B schematically illustrates the vertical angle (of the plasma streams 230 in relation to the outer wall of the calcination reactor 108, which may e.g. be around 90 degrees. The vertical angle β may also be much larger than 90 degrees, e.g. so as to make the plasma streams 230 horizontal. In the schematically illustrated embodiment, the input material is injected more or less directly into the plasma streams 230, so that the swirl flow of the input material is enhanced even further. This may also aid in ensuring that the plasma streams 230 do not come too close to the walls of the calcination reactor 108.

In embodiments, the swirl flow enhancing arrangement 250 comprises one or more additional injection arrangements 109, arranged below the main injection arrangement 106 for the input material. The one or more additional injection arrangements 109 may inject gas or further input material at an angle in relation to the outer wall of the calcination reactor 108, with the purpose of enhancing the swirl flow in the calcination reactor 108. In embodiments where the calcination system comprises a particle separator 110, smaller particles (e.g. with a diameter <10 μm), that have been separated from the remainder of the input material, may be injected into the calcination reactor 108 using the one or more additional injection arrangements 109, in order to enhance the swirl flow in the calcination reactor 108. The injection may use an injection gas, e.g. carbon dioxide or steam. The injection gas is in embodiments recycled carbon dioxide recovered from the calcination process. An embodiment of a calcination reactor comprising two additional injection arrangements 109 arranged at different horizontal levels below the main injection arrangement 106 for the input material is schematically illustrated in FIGS. 5C-D. As schematically illustrated in FIG. 5C, the additional injection arrangements 109 may e.g. be arranged with a vertical injection angle in relation to the outer wall of the calcination reactor 108 of around 90 degrees. However, the vertical angle may also be much larger than 90 degrees, e.g. so as to make the additional injection arrangements 109 horizontal. As schematically illustrated in FIG. 5D, the horizontal injection angle is preferably smaller than 90 degrees.

A swirl flow enhancing arrangement 250 comprising one or more additional injection arrangements 109 may comprise only one additional injection arrangement 109, or a plurality of additional injection arrangements 109. They may be arranged at different horizontal levels, as schematically illustrated in FIG. 5C, or at the same horizontal level. The main part of the input material may be injected through a main injection arrangement 106, and/or through a forma 215, as schematically illustrated in FIG. 5E.

In embodiments, the swirl flow enhancing arrangement 250 comprises an arrangement for injecting the input material directly into the at least one plasma stream 230. All of the input material may be injected in this way, or just smaller particles (e.g. with a diameter <10 μm) that have been separated from the remainder of the input material in the particle separator 110. FIG. 5E schematically illustrates an electric gas plasma generator 214 comprising a nozzle called forma 215, configured to inject the plasma stream 230 into the calcination reactor 108. In the schematically illustrated embodiment, at least a part of the input material is injected into the forma 215, and thereby directly into the plasma stream 230 of the electric gas plasma generator 214. If smaller particles are separated from the remainder of the input material in the particle separator 110, it is especially advantageous to inject only the remainder of the input material in this way. Smaller particles may be burned if injected directly into the plasma stream 230, but typically need less heating to be calcinated. The smaller particles may be injected through a main injection arrangement 106 for the input material, and/or through one or more additional injection arrangements 109.

In embodiments, the swirl flow enhancing arrangement 250 comprises adapting the injection of the input material to the swirl of the at least one plasma stream 230. The plasma stream 230 typically has a swirl as it leaves the electric plasma generator, and by adapting the injection of the input material to this swirl, the swirl and/or rotation of the input material flow is enhanced.

The swirl flow enhancing arrangement 250 may also be arranged in the form of a cyclone.

In embodiments, an optional swirl flow maintainer or enhancer 304 is configured to receive heated material and resulting process products generated by the heat treatment of the material in the primary calcination reactor 302, such as solid calcination process products and gas formed calcination process products in the form of carbon dioxide, when applied in a lime recovery cycle. The temperature of the calcination process products received from the primary calcination reactor 302 typically exceeds 900 degrees Celsius and in embodiments are typically in the range of 1200 degrees Celcius.

In embodiments, the swirl flow maintainer 304 is configured to reinforce and/or maintain the flow rate in a swirling flow of the received heated material, and to output material with an enhanced and/or maintained flow rate. The swirl flow maintainer or enhancer is in embodiments in the form of a cyclone. In other embodiments, the swirl flow maintainer 304 may be a vessel preferably configured to maintain or enhance a swirling flow of the material before it is output and transferred to the secondary calcination reactor 306.

The swirl flow enhancing and/or maintainer arrangement described in this disclosure may be applied independently or in combination with other embodiments described herein.

### First and Second Calcination Chambers

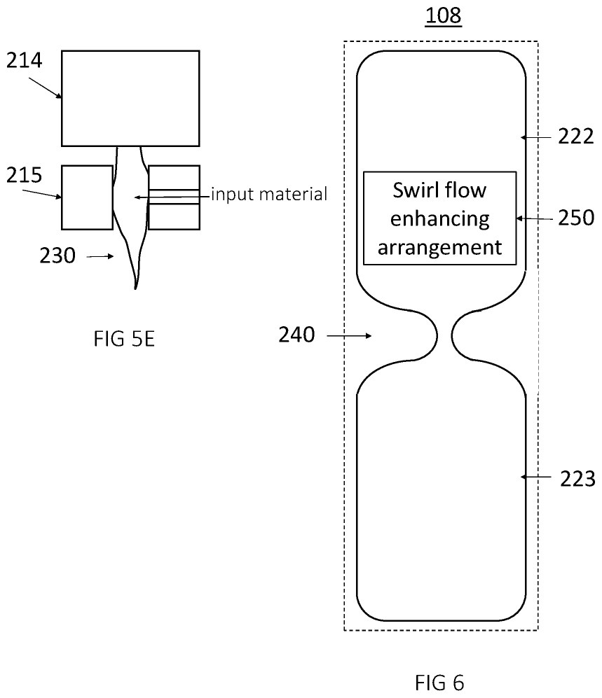

FIG. 6 schematically illustrates an embodiment of a calcination reactor 108 comprising a first calcination chamber 222 and a second calcination chamber 223, partially partitioned from each other, for example by a waist structure 240. The input material is preferably transferred into the second calcination chamber 223 in such a way that a swirling flow is maintained also in the second calcination chamber 223.

Larger particles of the input material are typically held for a longer time in the first calcination chamber 222, allowing them a longer calcination time, whereas smaller particles (e.g. with a diameter <10 μm), that are calcinated in a shorter time, move faster into the second calcination chamber 223. The shape of the first calcination chamber 222 and/or the second calcination chamber 223 may be cylindrical and/or at least partly conical, in order to promote the whirl or the rotation of the flow of material, so as to maintain a certain time of presence of the particles of the material in the chambers.

### Secondary Calcination Reactor

In embodiments, the calcination is carried out in more than one calcination chamber. In such embodiments, a primary calcination chamber is heated and one or more secondary calcination chambers are non-heated. In other embodiments, also one or more secondary calcination chambers may be heated.

In embodiments, a calcination reactor arrangement 108,300 or a calcination system 100, comprises an electrically heated primary calcination reactor chamber 222,302 having an inlet 312 for input material; and a secondary calcination reactor chamber 223,306 configured to receive a flow of material from the primary calcination reactor chamber 222,302 and to maintain a flow of the material through the secondary reactor chamber 223,306. Embodiments of a calcination method, comprises injecting input material into an electrically heated primary calcination reactor chamber; receiving, in a secondary calcination reactor chamber, a flow of material from the primary calcination reactor chamber, and maintaining a flow of the material through the secondary reactor chamber.

In embodiments, the secondary calcination reactor 306 is a non-heated calcination reactor configured to receive a flow of heated material from the primary calcination reactor 302 or from the swirl flow maintainer 304.

In embodiments, the secondary calcination reactor 306 is configured to receive heated material having a temperature typically in the range between 1000-1200 and to maintain a temperature above 900 degrees Celsius, in order for the calcination process to continue within the secondary calcination reactor 306. Since the solid compound and the gas in the material has a high temperature from having been heated in the electrically heated and/or plasma heated primary calcination reactor 302, the calcination process will continue in the secondary calcination reactor 302 without further heating. As long as the material has a temperature above 900 degrees Celsius, the calcination process will continue, albeit at a slower pace as the temperature falls.

The secondary calcination reactor 302 is configured to exit the second calcination process products to a separator 118.

### Embodiments of Calcination Reactor Arrangement and Calcination Reactor

Referring to FIG. 1-6 and to the other sections of the present description, various embodiments are described and further explained in this section.

An embodiment of the reactor arrangement (300) in a plasma heated calcination system, comprises a primary calcination reactor (302) configured to be heated by a plasma stream (308) injected into the primary calcination reactor (302), to receive input material (310) via an inlet (312), to expose the input material to heat from the plasma stream (308) in a swirling flow (330) through the primary calcination reactor (308) and to output material that has been exposed to heat via an outlet (314) of the primary calcination reactor (302); and a secondary calcination reactor (306) configured to receive a flow of heated material from the primary calcination reactor (302) and to maintain a swirling flow (332) of the material through a space (340) of the secondary reactor (306). The primary calcination reactor has a primary calcination chamber and the secondary calcination reactor has a secondary calcination chamber.

The reactor arrangement may further comprise a swirl flow maintainer (304), for example in the form of a cyclone, configured to receive heated material from the primary calcination reactor (302), to reinforce and/or maintain the flow rate in a swirling flow (334) of the received heated material in a space 336, and to output material with an enhanced and/or maintained flow rate.

The primary and/or the secondary calcination reactors are preferably of a cyclone reactor type. In a cyclone calcination reactor, particles of input material whirl in a space where calcination takes place when the material is heated. In a cyclone reactor a whirling or rotating flow takes place in a vessel that typically has a substantially rotationally symmetric, cylindrical or conical shape. Material comprising solid particles as well as gas flows in a whirling or helical pattern in a space in the reactor vessel. Normally, material is input at an upper part of the reactor, flows through the reactor and is output at a lower part of the reactor.

The reactor arrangement may further be configured such that the secondary reactor (306) receives the heated material from the swirl flow maintainer (304).

In embodiments, the input material is injected into the primary calcination reactor (302) such that a swirling flow is generated or promoted and wherein the primary calcination reactor (302) is configured such that the input material is exposed to heat from the plasma stream in a swirling flow (330) through the primary calcination reactor (302).

In embodiments, the input material is injected into the primary reactor tangentially in relation to a rotational symmetry axis of reactor vessel, and preferably the heated material is similarly received into the secondary calcination reactor and/or the swirl maintainer.

In embodiments, the primary calcination reactor (302) comprises a first space (320) and a second space (322) that are partially partitioned from each other, for example by a waist structure (324). Preferably, the reactor is configured such that a plasma stream (308) is injectable into the first space (320) by a plasma generator (330) to reach past the waist structure (324) into the second space (322).

In embodiments, the plasma generator (330) is configured to contribute to swirl of input material in the first space (320). In embodiments, flow conducting flanges are configured to conduct gas injected at the arc of the plasma generator to induce a swirling shape or flow of the plasma stream (plasma torch or plasma jet or plasma flame). The injection of the input material fluid is adapted to the swirl of the plasma stream and the swirl and/or rotation of the input material flow is thereby enhanced.

In embodiments, the volume of the first space (320) is smaller than the volume of the second space (322) of the primary calcination reactor (302), for example in the range of 10-30 percent of the volume of the second space.

Larger particles of the material is held for a longer time in the first space, allowing them a longer calcination time, whereas the smaller particles that are calcined in a shorter time move faster past the partition into the second space.

In embodiments, the reactor is configured such that the plasma stream is unable to reach reactor walls of the second space (322). In order to achieve this, the relative length of the plasma stream and the dimensions (e.g. diameter and length) of the second space is adapted such that there is a sufficient margin from the plasma stream to the vessel walls of the reactor not to expose the walls to the high temperature that prevails in the immediate vicinity of the plasma stream (or plasma torch/plasma jet/plasma flame).

The shape of the primary reactor, the secondary reactor and/or the swirl maintainer may be cylindrical and/or at least partly conical in order to promote the whirl or the rotation of the flow of material in order to maintain a certain time of presence of the particles of the material in the reactors.

The temperature of the material in the primary reactor is more than 900 degrees Celsius and exits from the primary reactor after about 2 seconds in the second space at a typical temperature in the range of about 1200 degrees Celsius. In embodiments comprising a whirl maintainer, the flow of material continues to whirl or circulate for a certain time for example in the range of 2 seconds during which calcination continues and temperature is decreased, for example to about 1000 degrees Celsius. In embodiments, where the secondary reactor receives heated material from the primary reactor at about 1200 degrees Celsius or from the whirl maintainer at about 1000 degrees Celsius, the calcination continues during a maintained whirl or circular flow until material 342 mainly in the form of calcination process products exits at about 950 degrees Celsius. In the secondary reactor, gas may spend typically about 2 seconds and solid particles a longer time before exit.

In embodiments, a reactor arrangement or a reactor as described above is comprised in a calcination system as described in the present disclosure.

An embodiment of a calcination system (100), comprises:

a plasma heated calcination reactor arrangement (300) having
a primary calcination reactor (302) configured to be heated by a plasma stream (308) injected into the primary calcination reactor (302), to receive input material (310) via an inlet (312), to expose the input material to heat from the plasma stream (308) in a swirling flow through the primary calcination reactor (308) and to output material that has been exposed to heat via an outlet (314) of the primary calcination reactor (302); and
a secondary calcination reactor (306) configured to receive a flow of heated material from the primary calcination reactor (302) and to maintain a swirling flow of the material through the secondary reactor (306); the reactor arrangement (300) being configured to convert lime mud into calcination process products comprising a solid compound and a gas in the form of carbon dioxide; and
   a separator (118), configured to receive the calcination process products from the calcination reactor arrangement (300), and to separate the calcium oxide from the carbon dioxide.

Embodiments of the calcination system (100) further comprises: an input (102) for receiving input material in the form of lime mud; a media separated heat exchanger (104), coupled to the input and configured to conduct the input material in a plurality of channels; and an injection arrangement (106), configured to receive the lime mud from the media separated heat exchanger (104) and inject it into the electrically heated calcination reactor arrangement (300).

Embodiments of the calcination system (100) further comprises: a particle separator (110) coupled to the injection arrangement (106) and configured to separate larger lumps and smaller particles of solid compound in the input material, and to convey the smaller particles in a gas flow to the injection arrangement (106) for injection into the electrically heated calcination chamber (222).

Embodiments of the calcination system (100) further comprises a filter arrangement (122), configured to receive gas in the form of carbon dioxide from at least one of the separators (112, 118), and filter the gas to a higher degree of purity.

Embodiments of the calcination system (100) further comprises a control unit (126), communicatively coupled to sensors and control actuators, and configured to receive sensor signals, generate control signals and communicate control signals through a control port (128) connected to one or more signal lines (130) coupled to the sensors and control actuators.

In embodiments of the calcination system (100), the control unit is configured to control one or more of: a driving gas supply (105) into the media separated heat exchanger (104); injecting gas supply (107) into the injection arrangement (106);
gas heating in the particle separator (110); gas pressure in the primary calcination reactor (302); and/or temperature in the primary calcination reactor (302).

Embodiments of the calcination system (100) further comprises a reactor arrangement (300) or a reactor as described in the present disclosure.

Embodiments of a calcination method (400), comprises: injecting (430) lime mud into an electrically heated calcination reactor arrangement (300); converting (440), in a primary calcination reactor (302), lime mud into heated material in the form of a first mixture of uncalcined lime mud and calcination process products comprising a solid compound and a gas in the form of carbon dioxide by exposing the injected lime mud to heat from a plasma stream injected into the primary calcination reactor (308) in a swirling flow through the primary calcination reactor (308); outputting (445) the heated material from the primary calcination reactor (308);—optionally, receiving (450) the heated material and reinforcing the flow rate in a swirling flow of the received heated material, in a swirl flow maintainer (304), for example in the form of a cyclone, and outputting the heated material with an maintained flow rate; receiving (455) the heated material in a secondary calcination reactor (306); converting (460), in the secondary calcination reactor (306) while maintaining a swirling flow, the heated material into a second mixture of uncalcined lime mud and calcination process products comprising calcium oxide and gas in the form of carbon dioxide; transferring (465) the second mixture to a separator (118); and separating (470), in the separator (118), the calcium oxide from the carbon dioxide gas.

In embodiments of the calcination method, the input material is injected into the primary calcination reactor (302) such that a swirling flow is generated or promoted and wherein the primary calcination reactor (302) is configured such that the input material is exposed to heat from the plasma stream in a swirling flow through the primary calcination reactor (302).

Embodiments of the calcination method further comprises contributing, by the plasma generator (330), to swirl of input material in the first space (320).

Embodiments of the calcination method further comprises injecting the plasma stream (308) into a first space (320) of the primary calcination reactor (302) by a plasma generator (330) such that the plasma stream (308) reaches into a second space (322) of the primary calcination reactor (302) past a waist structure (324) that is configured to partially partition the first space (320) from the second space (322).

In embodiments of the calcination method, the volume of the first space (320) is smaller than the volume of the second space (322) of the primary calcination reactor (302), for example in the range of 10-30 percent of the volume of the second space.

Embodiments of the calcination method further comprises injecting the plasma stream (308) such that it is unable to reach reactor walls of the second space (322).

Embodiments of the calcination method further comprise: receiving (410) input material in the form of lime mud; conducting (415) the input material in a plurality of channels of a media separated heat exchanger (104); and using an injection arrangement (106) when injecting (430) the lime mud into the primary calcination reactor (302).

Embodiments of the calcination method further comprises separating (420), in a particle separator (110) coupled to the injection arrangement (106), larger lumps from smaller particles of solid compound in the input material, and conveying the smaller particles in a gas flow to the injection arrangement (106) for injection into the primary calcination reactor (302).

Embodiments of the calcination method further comprises filtering (480), in a filter arrangement (122) gas in the form of carbon dioxide, received from the separator (118), to a higher degree of purity.

Embodiments of the calcination method further comprise: in a control unit (126) communicatively coupled to sensors and control actuators, receiving sensor signals, generating control signals and communicating control signals through a control port (128) connected to one or more signal lines (130) coupled to the sensors and control actuators.

Embodiments of the calcination method further comprises controlling one or more of: driving gas supply (105) into the media separated heat exchanger (104);
injecting gas supply (107) into the injection arrangement (106); gas heating in the particle separator (110); gas pressure in the primary calcination reactor (302); and/or temperature in the primary calcination reactor (302).

General embodiments of a calcination reactor arrangement (300), comprises an electrically heated primary calcination reactor (302) having an inlet (312) for input material and an outlet (314) for output of heated material; a secondary calcination reactor (306) configured to receive a flow of heated material from the primary calcination reactor (302) and to maintain a flow of the material through the secondary reactor (306). Further general embodiments comprise a reactor arrangement (300) with a selection of one or more of the features and functions described in the present disclosure.

An embodiment of a plasma heated calcination reactor (302), having a plasma generator (330); an inlet (312) for input material and an outlet (314) for output of heated material, comprises a first space (320) and a second space (322) that are partially partitioned from each other, for example by a waist structure (324).

In embodiments the calcination reactor (302) is configured such that a plasma stream (308) is injectable into the first space (320) by a plasma generator (330) to reach, past the partition for example a waist structure (324), into the second space (322).

In embodiments the calcination reactor (302) the plasma generator (330) is configured to contribute to swirl of input material in the first space (320).

In embodiments the calcination reactor (302) is configured such that the volume of the first space (320) is smaller than the volume of the second space (322) of the primary calcination reactor (302), for example in the range of 10-30 percent of the volume of the second space.

In embodiments the calcination reactor (302) is configured such that the plasma stream (308) is unable to reach reactor walls of the second space (322).

In embodiments the calcination reactor (302) the input material is injected into the calcination reactor (302) such that a swirling flow is generated or promoted and wherein the calcination reactor (302) is configured such that the input material is exposed to heat from the plasma stream in a swirling flow through the primary calcination reactor (302).

In embodiments the calcination reactor (302) a material is calcined in a plasma heated calcination reactor; wherein material is input into a first space (320) of the calcination reactor to swirl around a plasma stream and then transferred to a second space (322) of the calcination reactor that is partially partitioned from the first space (320).

In embodiments the calcination reactor (302) a plasma stream (308) is injected into the first space (320) by a plasma generator (330) to reach into the second space (322).

Embodiments of the calcination reactor (302) are configured such that the plasma generator (330) contributes to swirl of input material in the first space (320).

In embodiments of the calcination reactor (302) the volume of the first space (320) is smaller than the volume of the second space (322) of the calcination reactor (302), for example in the range of 10-30 percent of the volume of the second space.

In embodiments of the calcination reactor (302), the plasma stream (308) is configured to be unable to reach reactor walls of the second space (322).

In embodiments the calcination reactor (302), the input material is injected into the calcination reactor (302) such that a swirling flow is generated or promoted and wherein the input material is exposed to heat from the plasma stream in a swirling flow through the calcination reactor (302).

The calcination reactor arrangement and calcination reactor described in this disclosure may be applied independently or in combination with other embodiments described herein.

### Separator

The calcination process products and possible residual uncalcined material components are conducted from the secondary calcination reactor 302 to a separator 118 configured to separate the calcination process products such that solid compounds are separated from gas. In embodiments the separator 118 is a cyclone. In embodiments of the calcination system configured for lime recovery from lime mud, calcium oxide is separated from carbon dioxide. Solid compounds, such as calcium oxide in lime calcination embodiments, is in embodiments collected in a collection hopper and the gas, such as carbon dioxide, may be conducted to a filter arrangement 122.

Since the calcination process stops when the temperature falls below 900 degrees Celsius, a heat recovery system may be arranged after the secondary calcination reactor 302, to recover the heat energy from the calcination process products. Such a heat recovery system is preferably arranged after the separation of the gas from the solid compound.

In embodiments applied for lime recovery from a lime mud, the residual calcination process products output from the separator 118 will comprise and usually mainly consist of carbon dioxide and fine-grained residual calcium oxide (quick lime). In embodiments of such lime recovery, a separation ratio in a cyclone variant of the separator 118 would for example be in the range of 75% of the calcium oxide input from the calcination reactor 108 being collected in the collection hopper and in the range of 25% of the calcium oxide being output from the separator 118 together with the carbon dioxide.

Embodiments of the calcination system 100 comprise: a separator 118 configured to receive calcination process products output from the secondary calcination reactor 302, the separator 118 being configured to separate solid compound, for example in the form of calcium oxide, from the gas, for example in the form of carbon dioxide. Embodiments of the calcination method comprise separating, in a separator 118, calcination process products received from the secondary calcination reactor 302, such that further solid compound, for example in the form of calcium oxide, is separated from the gas, for example in the form of carbon dioxide.

### Filter Arrangement

The filter arrangement 122, comprised in embodiments, is configured to filter the gas component of the calcination process products to a higher degree of purity before collecting, storing and/or using the output gas. In lime calcination embodiments, the gas component of the calcination process products is carbon dioxide. In such embodiments, the filter arrangement 122 would comprise a filter adapted to filter carbon dioxide. The filtered gas component of the calcination process products is conducted to a gas output 124. If the temperature of the gas has been decreased to a low temperature of e.g. 200 degrees Celsius, textile filters may be applied.

The filter arrangement 122 is in embodiments configured to filter out possible dust and such impurities still present in the gas output from the second separator 118. The filter arrangement is selected to fit to the temperature levels of the gas from the separator 118.

Embodiments of the calcination system comprise a filter arrangement 122 configured to receive gas, for example in the form of carbon dioxide, from one or more separators 118 and to filter the gas to a higher degree of purity. Embodiments of the calcination method comprises filtering, in a filter arrangement 122, gas, for example in the form of carbon dioxide, received from one or more separators 118, such that the gas is filtered to a higher degree of purity.

### Gas Output

The gas output 124 is configured to receive the gas component of the calcination process products, and is in different embodiments configured to store, temporarily or for a longer term, or conduct the gas to the calcination system itself or to other systems and/or processes. In lime calcination embodiments the gas conducted to the gas output 124 would be carbon dioxide, and would in embodiments be recirculated to a calcination reactor of the calcination reactor arrangement 108,300.

### Control Unit

A control unit 126, comprised in embodiments, is configured to receive sensor signals, to generate control signals and to communicate control signals through a control port 128 connected to one or more signal lines 130. The one or more signal lines is schematically indicated as an intermittent line that is connected to sensors and/or control actuators (not shown) at different points and components of the calcination system in order to control various parameters.

Embodiments of the calcination system 100 comprise a control unit 126 communicatively coupled to sensors and control actuators and configured to receive sensor signals, to generate control signals and to communicate control signals through a control port 128 connected to one or more signal lines 130 coupled to the sensors and control actuators. Embodiments of the calcination method comprise in a control unit 126 communicatively coupled to sensors and control actuators, receiving sensor signals, generating control signals and communicating control signals through a control port 128 connected to one or more signal lines 130 coupled to the sensors and control actuators.

In embodiments of the calcination system 100, the control unit is configured to control one or more of: driving gas supply 105 into the media separated heat exchanger 104; injection gas supply 107 into the injection arrangement 106; heated gas in the particle separator 110; gas pressure in the primary calcination reactor 302; and/or temperature in the primary calcination reactor 302. Embodiments of the calcination method, further comprises controlling one or more of: driving gas supply 105 into the media separated heat exchanger 104; injection gas supply 107 into the injection arrangement 106; heated gas in the particle separator 110; gas pressure in primary calcination reactor 302; and/or temperature in the primary calcination reactor 302.

### Preheating with a Media Separated Heat Exchanger

The purpose of using a media separated heat exchanger 104 as a preheater is to raise the temperature of the input material without recirculation of material. Embodiments of the calcination system 100 comprise a media separated heat exchanger 104 coupled to the input and configured to conduct input material in a plurality of channels, for example tubes. Embodiments of a calcination method comprises conducting the input material in a plurality of channels of a media separated heat exchanger 104. Other embodiments comprise other types of heat exchangers or preheaters.

Input material, such as lime mud, may pass through and be heated by the media separated heat exchanger 104, and is output to an injection arrangement 106 via an outlet (not shown) from the media separated heat exchanger 104. In a configuration of the calcination system applied for lime recovery, the input material in the form of lime mud e.g. has a temperature of 500-600 degrees Celsius, but ideally holds a temperature in the range of 900 degrees Celsius when it leaves the media separated heat exchanger 104. Similarly, in other embodiments having other types of heat exchangers or preheaters, the input material is preheated to e.g. a temperature of 500-600 degrees Celsius, but ideally to a temperature in the range of 900 degrees Celsius.

If a heat recovery system is arranged after the calcination reactor arrangement 108,300 (preferably arranged after the separation of the gas from the solid compound), heat energy from the calcination process products may be used in the media separated heat exchanger 104.

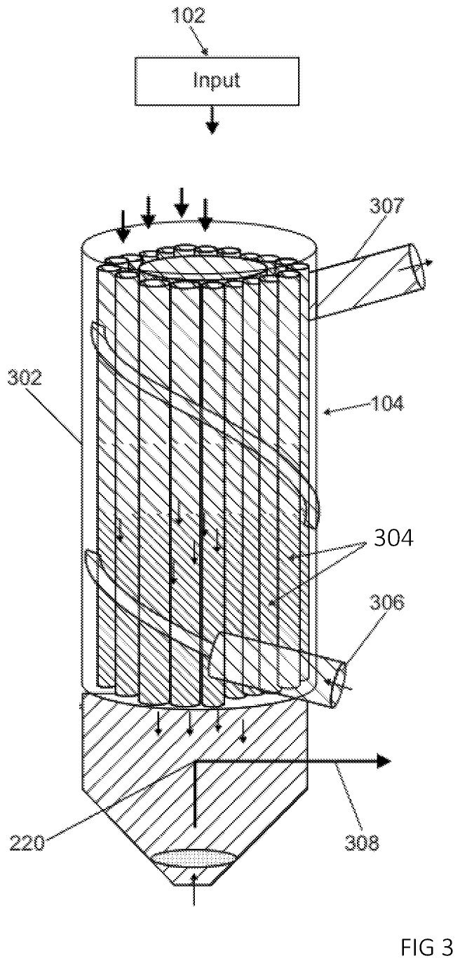

An embodiment of the media separated heat exchanger 104 is shown in FIG. 3. FIG. 3 shows a media separated heat exchanger 104 for use in a system 100 for calcination of lime mud, or in any other system for heating of fine-grained solid material, in accordance with embodiments herein. The illustrated media separated heat exchanger 104 comprises an outer shell 302 and one or more tubes 304 arranged inside the shell 302. The illustrated media separated heat exchanger 104 comprises an outer shell 302 and one or more tubes 304 arranged inside the shell 302. In operation, a first medium being input material, e.g lime mud, is lead through the tubes, and hot gas, e.g. carbon dioxide, is led outside the tubes within the outer shell, or vice versa.

The media separated heat exchanger may be used together with any type of calcination reactor or calcination reactor arrangement.

### General Embodiments of a Calcination System and a Calcination Method

Embodiments of a calcination reactor arrangement 108,300 and a calcination system 100, comprise:
an electrically heated primary calcination reactor chamber (222,302) having an inlet (312) for input material; and a secondary calcination reactor chamber (223,306) configured to receive a flow of material from the primary calcination reactor chamber (222,302) and to maintain a flow of the material through the secondary reactor chamber (223,306).

Further embodiments of a calcination system 100 comprise: an electrically heated and/or plasma heated primary calcination reactor having a primary calcination chamber, configured to convert input material, e.g. lime mud, into first calcination process products comprising a solid compound and a gas in the form of carbon dioxide; a first separator 112, configured to receive the first calcination process products from the electrically heated first calcination chamber 222, and separate the solid compound from the carbon dioxide; an optionally thermally insulated second calcination chamber 200 of a secondary calcination reactor, configured to receive the solid compound, and convert it into second calcination process products comprising calcium oxide and carbon dioxide; and a second separator 118, configured to receive the second calcination process products from the thermally insulated second calcination chamber 200, and separate the calcium oxide from the carbon dioxide. This is schematically illustrated in FIGS. 1A-D and 2A-B.

Embodiments of a calcination method, comprise injecting input material into an electrically heated primary calcination reactor chamber; receiving, in a secondary calcination reactor chamber, a flow of material from the primary calcination reactor chamber, and maintaining a flow of the material through the secondary reactor chamber.

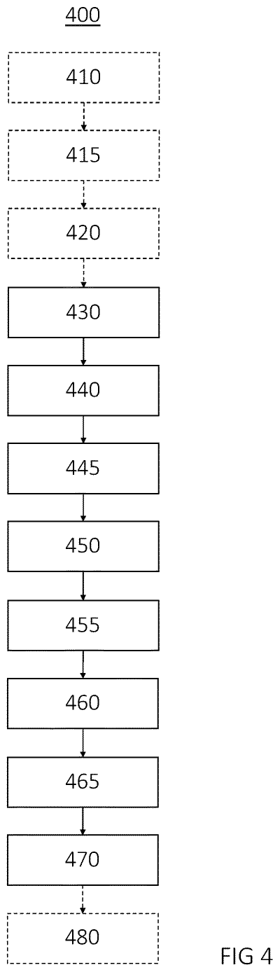

Embodiments of a calcination method 400 comprise: injecting 430 lime mud into an electrically heated first calcination chamber 222; converting 440, in the electrically heated first calcination chamber 222, lime mud into first calcination process products comprising a solid compound and a gas in the form of carbon dioxide; transferring 445 the first calcination process products to a first separator 112; separating 450, in the first separator 112, the solid compound from the gas in the form of carbon dioxide; transferring 455 the solid compound to a thermally insulated second calcination chamber 200; converting 460, in the thermally insulated second calcination chamber 200, the solid compound into second calcination process products comprising calcium oxide and gas in the form of carbon dioxide; transferring 465 the second calcination process products to a second separator 118; and separating 470, in the second separator 118, the calcium oxide from the gas in the form of carbon dioxide. This is schematically illustrated in FIG. 4.

The foregoing disclosure is not intended to limit the present disclosure to the precise forms or particular fields of use disclosed. It is contemplated that various alternate embodiments and/or modifications to the present embodiments, whether explicitly described or implied herein, are possible in the light of the disclosure. Embodiments described in this disclosure may be applied independently or in combination with other embodiments described herein.

For example, the system according to the illustrated embodiments comprises a media separated heat exchanger, but it is not necessary for the system to comprise a media separated heat exchanger—the input material may instead be input directly into the electrically heated first calcination chamber or be preheated by means of a preheating arrangement. Further, the first calcination reactor 108 may comprise one or more unheated additional calcination chambers arranged after the electrically heated first calcination chamber 222, where the calcination process may continue without any external heating, before separating off the gas. Accordingly, the scope of is defined only by the accompanying patent claims.

1. A calcination reactor arrangement comprising:
an electrically heated primary calcination reactor chamber having an inlet for input material; and
a secondary calcination reactor chamber configured to receive a flow of material from the primary calcination reactor chamber and to maintain a flow of the material through the secondary reactor chamber.

2. The reactor arrangement of claim 1, in a plasma heated calcination system, comprising:
a primary calcination reactor, having a primary calcination reactor chamber, configured to be heated by a plasma stream injected into the primary calcination reactor, to receive input material via an inlet, to expose said input material to heat from the plasma stream in a swirling flow through the primary calcination reactor and to output material that has been exposed to heat via an outlet of said primary calcination reactor, said primary calcination reactor for example being a cyclone reactor; and
a secondary calcination reactor, having a secondary reactor chamber, configured to receive a flow of heated material from the primary calcination reactor and to maintain a swirling flow of the material through the secondary reactor, said secondary reactor calcination reactor for example being a cyclone reactor.

3. The reactor arrangement of claim 2, further comprising a
a swirl flow maintainer configured to receive heated material from the primary calcination reactor, to reinforce and/or maintain the flow rate in a swirling flow of the received heated material, and to output material with an enhanced and/or maintained flow rate.

4. The reactor arrangement of claim 3, further being configured such that the secondary reactor receives the heated material from the swirl flow maintainer.

5. The reactor arrangement of claim 1, wherein the input material is injected into the primary calcination reactor such that a swirling flow is generated or promoted and wherein the primary calcination reactor is configured such that the input material is exposed to heat from the plasma stream in a swirling flow through the primary calcination reactor.

6. The reactor arrangement of claim 1, wherein the primary calcination reactor comprises a first space and a second space that are partially partitioned from each other.

7. The reactor arrangement of claim 6, being configured such that a plasma stream is injectable into the first space by a plasma generator to reach past the partial partition structure into the second space.

8. The reactor arrangement of claim 1, wherein the plasma generator is configured to contribute to swirl of input material in said first space.

9. The reactor arrangement of claim 6, being configured such that the volume of the first space is smaller than the volume of the second space of said primary calcination reactor.

10. The reactor arrangement of claim 6, being configured such that the plasma stream is unable to reach reactor walls of the second space.

11. The reactor arrangement of claim 1, comprising a swirl flow enhancing arrangement.

12. The reactor arrangement of claim 1, comprising an electric gas plasma generator.

13. The reactor arrangement of claim 1, wherein the electric gas plasma generator is arranged to inject one or more plasma streams into the calcination reactor at an angle in relation to the outer wall of the calcination reactor, as a part of a swirl flow enhancing arrangement.

14. The reactor arrangement of claim 1, wherein the electric gas plasma generator comprises a nozzle called forma, configured to inject the gas plasma stream into the calcination reactor, and at least a part of the input material is injected into the forma, and thereby directly into the gas plasma stream.

15. The reactor arrangement of claim 1, wherein a swirl flow enhancing arrangement, comprised in the calcination reactor arrangement, comprises at least one additional injection arrangement, arranged below the main injection arrangement, wherein smaller particles of solid compound, which have been separated from the remainder of the input material, are conveyed in a gas flow for injection into the calcination reactor through the at least one additional injection arrangement.

16. The reactor arrangement of claim 1, configured to convert input material into calcination process products comprising gas and a solid compound.

17. A calcination system, comprising:
an electrically heated calcination reactor arrangement comprising:
an electrically heated primary calcination reactor chamber having an inlet for input material;
a secondary calcination reactor chamber configured to receive a flow of material from the primary calcination reactor chamber and to maintain a flow of the material through the secondary reactor chamber.

18. The calcination system of claim 17, comprising:
a plasma heated calcination reactor arrangement comprising:
a primary calcination reactor, having a primary calcination chamber, configured to be heated by a plasma stream injected into the primary calcination reactor, to receive input material via an inlet, to expose said input material to heat from the plasma stream in a swirling flow through the primary calcination reactor and to output material that has been exposed to heat via an outlet of said primary calcination reactor; and
a secondary calcination reactor, having a secondary calcination chamber, configured to receive a flow of heated material from the primary calcination reactor and to maintain a swirling flow of the material through the secondary reactor; said reactor arrangement being configured to convert lime mud into calcination process products comprising a solid compound and a gas in the form of carbon dioxide; and
a separator, configured to receive said calcination process products from the calcination reactor arrangement, and to separate said calcium oxide from said carbon dioxide.

19. The calcination system of claim 17, further comprising:
an input for receiving input material in the form of lime mud;
a heat exchanger, coupled to said input and configured to conduct the input material through the heat exchanger; and
an injection arrangement, configured to receive the lime mud from the heat exchanger and inject it into the electrically heated calcination reactor arrangement.

20. The calcination system of claim 19, further comprising:
a particle separator coupled to the injection arrangement and configured to separate larger lumps and smaller particles of solid compound in the input material, and to convey said smaller particles in a gas flow to said injection arrangement for injection into said electrically heated calcination chamber.

21. The calcination system of claim 17, further comprising a filter arrangement, configured to receive gas in the form of carbon dioxide from the separator or a separator, and filter said gas to a higher degree of purity.

22. The calcination system of claim 17, further comprising a control unit communicatively coupled to sensors and control actuators, and configured to receive sensor signals, generate control signals and communicate control signals through a control port connected to one or more signal lines coupled to said sensors and control actuators.

23. The calcination system of claim 22, wherein the control unit is configured to control one or more of:
driving gas supply into a heat exchanger;
injecting gas supply into an injection arrangement;
gas heating in a particle separator;
gas pressure in the primary calcination reactor; and/or
temperature in the primary calcination reactor.

24. The calcination system of claim 17, wherein the calcination reactor is configured to convert input material into calcination process products comprising gas and a solid compound.
wherein the calcination system further comprises a separator configured to receive the calcination process products from the calcination reactor and separate away the gas from the solid compound, and
wherein the calcination reactor is heated using a reactor heating arrangement and comprises a swirl flow enhancing arrangement.

25. The calcination system of any of claim 24, wherein the reactor heating arrangement comprises an electric gas plasma generator (214).

26. The calcination system of claim 25, wherein the electric gas plasma generator is arranged to inject one or more plasma streams into the calcination reactor at an angle in relation to the outer wall of the calcination reactor, as a part of the swirl flow enhancing arrangement.

27. The calcination system of claim 25, wherein the electric gas plasma generator comprises a nozzle called forma, configured to inject the gas plasma stream into the calcination reactor, wherein at least a part of the input material is injected into the forma, and thereby directly into the gas plasma stream.

28. The calcination system of claim 24, wherein the swirl flow enhancing arrangement comprises at least one additional injection arrangement, arranged below the main injection arrangement and the calcination system comprises a particle separator, configured to separate smaller particles of solid compound from the remainder of the input material, and to convey the smaller particles in a gas flow for injection into the calcination reactor through the at least one additional injection arrangement.

29. The calcination system of claim 24, wherein the calcination reactor comprises two chambers which are partially partitioned from each other.

30. The calcination system of claim 24, further comprising:
an input for receiving input material;
a heat exchanger coupled to the input and configured to conduct the input material through the heat exchanger; and
an injection arrangement configured to receive the input material from the heat exchanger and inject it into the calcination reactor.

31. The calcination system of claim 24, further comprising a filter arrangement configured to receive gas from the separator and filter the gas to a higher degree of purity.

32. The calcination system of claim 17, being configured to convert input material into calcination process products comprising gas and a solid compound.

33. A calcination method, comprising:
injecting input material into an electrically heated primary calcination reactor chamber; and
receiving, in a secondary calcination reactor chamber, a flow of material from the primary calcination reactor chamber and maintaining a flow of the material through the secondary reactor chamber.

34. The calcination method of claim 33, comprising:
injecting input material, for example lime mud, into an electrically heated calcination reactor arrangement;
converting, in a primary calcination reactor, having a primary reactor chamber, input material into heated material in the form of a first mixture of uncalcined input material and calcination process products comprising a solid compound and a gas in the form of carbon dioxide by exposing the injected input material to heat from a plasma stream injected into the primary calcination reactor in a swirling flow through the primary calcination reactor;
outputting said heated material from the primary calcination reactor;
optionally, receiving said heated material and reinforcing the flow rate in a swirling flow of the received heated material, in a swirl flow maintainer and outputting said heated material with an enhanced and/or maintained flow rate;
receiving said heated material in a secondary calcination reactor;
converting, in said secondary calcination reactor while maintaining a swirling flow, said heated material into a second mixture of uncalcined material and calcination process products comprising an oxide and gas in the form of carbon dioxide;
transferring said second mixture to a separator; and
separating, in said separator, said oxide from said carbon dioxide gas.

35. The calcination method of claim 33, wherein the input material is injected into the primary calcination reactor such that a swirling flow is generated or promoted and wherein the primary calcination reactor is configured such that the input material is exposed to heat from a plasma stream in a swirling flow through the primary calcination reactor.

36. The calcination method of claim 33, further comprising: contributing, by a plasma generator, to swirl of input material in said first space.

37. The calcination method of claim 33, further comprising: injecting a plasma stream into a first space of the primary calcination reactor by a plasma generator such that said plasma stream reaches into a second space of said primary calcination reactor past a waist structure that is configured to partially partition said first space from said second space.

38. The calcination method of claim 37, wherein the volume of the first space is smaller than the volume of the second space of said primary calcination reactor.

39. The calcination method of claim 37, further comprising injecting the plasma stream such that it is unable to reach reactor walls of the second space.

40. The calcination method of any of claim 33, comprising:
injecting input material into a calcination reactor;
heating the calcination reactor using a reactor heating arrangement;
enhancing the swirl of the input material in the calcination reactor, using a swirl flow enhancing arrangement;
converting, in the calcination reactor, the input material into calcination process products comprising gas and a solid compound;
transferring the calcination process products to a separator; and
separating, in the separator, away the gas from the solid compound.

41. The calcination method of claim 40, wherein the reactor heating arrangement comprises an electric gas plasma generator.

42. The calcination method of claim 40, wherein the enhancing of the swirl of the input material using the swirl flow enhancing arrangement comprises injecting one or more plasma streams from the electric gas plasma generator into the calcination reactor at an angle in relation to the outer wall of the calcination reactor.

43. The calcination method of claim 41, wherein the electric gas plasma generator comprises a nozzle called forma configured to inject the gas plasma stream into the calcination reactor, and the injecting of the input material into the calcination reactor comprises injecting at least a part of the input material into the forma, and thereby directly into the gas plasma stream, as a part of the enhancing of the swirl of the input material using the swirl flow enhancing arrangement.

44. The calcination method of claim 40, further comprising arranging a calcination reactor to comprise two chambers which are partially partitioned from each other.

45. The calcination method of claim 40, further comprising separating, in a particle separator, smaller particles of solid compound from the remainder of the input material, and conveying the smaller particles in a gas flow to an additional injection arrangement, arranged below a main injection arrangement, for injection into the calcination reactor, as a part of the enhancing of the swirl of the input material using the swirl flow enhancing arrangement.

46. The calcination method of claim 33, further comprising:
receiving input material;
conducting said input material through a heat exchanger; and
using an injection arrangement when injecting the input material into the primary calcination reactor chamber.

47. The calcination method of claim 33, further comprising separating, in a particle separator coupled to an injection arrangement larger lumps from smaller particles of solid compound in the input material, and conveying said smaller particles in a gas flow to said injection arrangement for injection into said primary calcination reactor chamber.

48. The calcination method of claim 33, further comprising filtering, in a filter arrangement gas in the form of carbon dioxide, received from the separator, to a higher degree of purity.

49. The calcination method of claim 33, further comprising in a control unit communicatively coupled to sensors and control actuators, receiving sensor signals, generating control signals and communicating control signals through a control port connected to one or more signal lines coupled to said sensors and control actuators.

50. The calcination method of claim 33, further comprising controlling one or more of:
driving gas supply into a heat exchanger;
injecting gas supply into an injection arrangement;
gas heating in a particle separator;
gas pressure in a primary calcination reactor; or
temperature in a primary calcination reactor.
